(19) United States
(12) Patent Application Publication
(10) Pub. No.: US 2012/0320917 A1
(43) Pub. Date: Dec. 20, 2012

(54) APPARATUS AND METHOD FOR FORWARDING SCALABLE MULTICAST PACKET FOR USE IN LARGE-CAPACITY SWITCH

(75) Inventor: Jong-Tae SONG, Daejeon-si (KR)

(73) Assignee: Electronics and Telecommunications Research Institute, Daejeon (KR)

(21) Appl. No.: 13/526,945

(22) Filed: Jun. 19, 2012

(30) Foreign Application Priority Data
Jun. 20, 2011 (KR) 10-2011-0059709

(51) Int. Cl. H04L 12/56

(52) U.S. Cl. 370/390

(57) ABSTRACT

Provided are an apparatus and method for forwarding a multicast packet, which provide scalability of multicast so as to support various multicast patterns in a large-capacity multistage switching system for supporting many input/output ports. The multicast packet forwarding apparatus includes an input line card configured to generate multicast information including a partition identifier (ID) to which at least one output port of a received first packet belongs and a switch multicast ID to be used to determine a position of the output port in the partition, and generate second packets including the multicast information in the same number as the number of partitions, a switch fabric configured to transfer the second packet to at least one output port to which the first packet is output on the basis of the multicast information included in the second packet, and a plurality of output ports grouped into a plurality of partitions.

### CROSS-REFERENCE TO RELATED APPLICATION

This application claims the benefit under 35 U.S.C. §119(a) of a Korean Patent Application No. 10-2011-0059709, filed on Jun. 20, 2011, the entire disclosure of which is incorporated herein by reference for all purposes.

### BACKGROUND

1. Field

The following description relates to multicast switching technology, and more particularly, to a scalable multicast packet forwarding apparatus and method for efficiently supporting a number of multicast patterns capable of occurring in a large-capacity switch.

2. Description of the Related Art

Multicast technology is mainly used to effectively utilize network resources and effectively transmit real-time multimedia traffic.

The simplest multicast method is technology for replicating a packet in an input line card of a switch and switching the replicated packet as in a unicast method. In this case, a packet processor located in the input line card replicates a packet and switches the replicated packet to an output line card. A replication method in the input line card is simple. However, because the number of packets to be replicated is increased when a system capacity is increased and the number of output stages for multicast is increased, control load is increased and there is the limitation in supporting a large-capacity system.

As a method more efficient than the unicast method, a multicast operation is performed in a switch fabric. A multicast routing header (hereinafter referred to as MRH), which is a separate header for multicast routing, is added to a multicast packet to be sent to the switch fabric. Multicast information is recorded on the MRH in the form of a switch multicast identifier (ID) (SMID) for identifying an output stage of the switch fabric. The SMID may be expressed in the form of a bitmap or a serial number. When the SMID is the bitmap, a bit position is indicated by an output port number. For example, when a bit of a position of the bitmap corresponding to the SMID is 1, a packet is transmitted to a port corresponding to the position. In the case of a general SMID method, one ID is defined, a multicast pattern suitable for the ID is set, and data is transmitted to a predetermined multicast port according to a multicast ID. At this time, a multicast forwarding lookup table (MFLT) as shown in Table 1 is used inside the switch fabric so as to identify an output line card of a packet from the SMID.

TABLE 1

| SMID | Output port bitmap |
|---|---|
| . . . | . . . |
| 3 | 00000011₍₂₎ |

In a multicast switching system of the related art, the input line card receives and processes a packet through an external interface, and transfers the processed packet to the switch fabric. The switch fabric transfers the packet to an output port recorded on the MFLT with an SMID value of a multicast header added to the packet for routing inside the system. In order to support all multicast patterns, a size of the SMID should be the same as that of the bitmap. In this case, if the system capacity is increased, the number of ports is increased and the size of the multicast ID is increased and an amount of traffic is unnecessarily increased because the multicast ID with the increased size should be defined in an internal header. When the number of ports is increased, the number of possible multicast patterns is exponentially increased and hence a size of the MFLT is also increased.

As described above, there is a limitation in using the SMID lookup method of the related art in a large-capacity switch in which the number of ports is large. For example, a single switch such as Cisco's carrier routing system-3 (CRS-3) supports 1296 input/output ports. In this case, the total number of possible multicast patterns may be about 2̂1296=1.36×10̂320. In order to express all the patterns, 1296 bits (162 bytes) are necessary. When the 1296 bits (162 bytes) are recorded and transferred in the MRH, an amount of traffic is unnecessarily increased. Accordingly, the existing system supports a million SMIDs. However, this number is only a part of 1.36×10̂320 multicast patterns.

At present, there is a need for high-scalability development for supporting a large number of servers connected around a data center. For this, a switch with several hundreds to thousands of input and output ports is being developed and used. If a content-based switch system is generalized in a type in which cloud networking is coupled to a server and a router, large-capacity switching technology using many ports will develop as a single system. Accordingly, large-capacity system technology for supporting a larger number of ports in single equipment is expected to continuously develop. Although there may be various multicast patterns, it is difficult to accommodate all multicast patterns due to the limitation of memory resources of a switch fabric.

### SUMMARY

The following description relates to an apparatus and method for forwarding a multicast packet, which provide scalability of multicast so as to support various multicast patterns in a large-capacity multistage switching system for supporting many input/output ports.

In one general aspect, there is provided an apparatus for forwarding a multicast packet, comprising: an input line card configured to generate multicast information including a partition ID to which at least one output port of a received first packet belongs and an SMID to be used to determine a position of the output port in the partition, and generate second packets including the multicast information in the same number as the number of partitions; a switch fabric configured to transfer the second packet to at least one output port to which the first packet is output on the basis of the multicast information included in the second packet; and a plurality of output ports grouped into a plurality of partitions.

In another general aspect, there is provided a method of forwarding a multicast packet in a multicast packet forwarding apparatus including an input line card, a switch fabric connected to the input line card, and a plurality of output ports connected to the switch fabric, the method including: generating, by an input line card, multicast information including a partition ID to which at least one output port of an input first packet belongs and an SMID to be used to determine a position of the output port in the partition when the plurality of output ports are grouped into a plurality of partitions; generating, by the input line card, second packets including the multicast information in the same number as the number of partitions; and transferring, by a switch fabric, the second packet to at least one output port to which the first packet is output on the basis of the multicast information included in the second packet.

Other features and aspects will be apparent from the following detailed description, the drawings, and the claims.

### BRIEF DESCRIPTION OF THE DRAWINGS

FIG. 1 is a diagram illustrating an example of a configuration of an apparatus for forwarding a multicast packet;

FIG. 2 is a diagram illustrating an example of a configuration of an input line card of FIG. 1;

FIG. 3 is a diagram illustrating configurations of a partition ID and an SMID according to an embodiment;

FIG. 4 is a diagram illustrating an example of a configuration of a switch fabric of FIG. 1;

FIG. 5 is a diagram illustrating an example of an operation of the multicast packet forwarding apparatus according to an embodiment;

FIG. 6 is a diagram illustrating a configuration in which a switch fabric of the multicast packet forwarding apparatus is constituted by a multistage switch according to an embodiment;

FIG. 7 is a diagram illustrating an example of an MFLT when the switch fabric of FIG. 6 is constituted by the multistage switch;

FIG. 8 is a flowchart illustrating a method of forwarding a multicast packet according to an embodiment;

FIG. 9 is a flowchart illustrating an operation of the input line card according to an embodiment; and

FIG. 10 is a flowchart illustrating an operation of the switch fabric according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

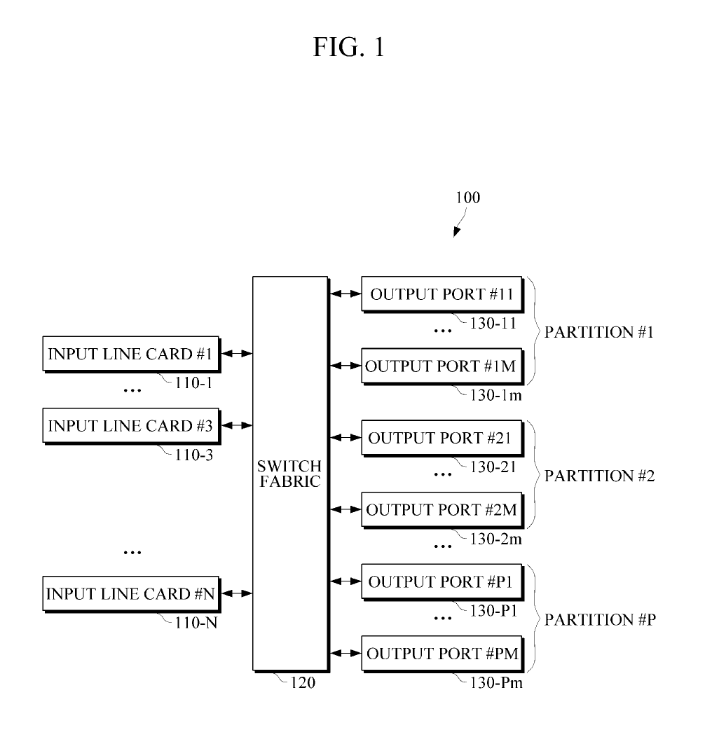

FIG. 1 is a diagram illustrating an example of a configuration of an apparatus for forwarding a multicast packet.

As illustrated in FIG. 1, the multicast packet forwarding apparatus 100 is constituted by a large-size switch/router system in which a plurality of input line cards 110-1 to 110-N and a plurality of output ports 130-11 to 130-Pm are connected to a switch fabric 120. At least one input port may be included in each of the plurality of input line cards 110-1 to 110-N. Each of the plurality of output ports 130-11 to 130-Pm corresponds to one output line card. In addition, is the plurality of input line cards 110-1 to 110-N may be configured to be the same as each other. Hereinafter, for convenience of description, the input line card 110-1 will mainly be described.

Usually, a size of an MFLT included in the switch fabric 120 is limited according to a capacity of hardware. In order to perform high-speed packet processing, the MFLT should be implemented inside a switching chip and its size is very limited. Accordingly, it is necessary to support various multicast patterns in a small size. According to an embodiment, the multicast packet forwarding apparatus is configured to significantly reduce the size of the MFLT and hence support a number of multicast patterns in a given environment.

For this, according to an embodiment, a plurality of output ports are grouped into a plurality of partitions. That is, when the number of output ports of the multicast packet forwarding apparatus 100 is N and the output ports are grouped into P partitions, each partition includes N/P output ports.

For convenience of description, a packet input to the multicast packet forwarding apparatus 100 is referred to as a first packet, and a packet obtained by processing the first packet according to a multicast pattern in the multicast packet forwarding apparatus 100 is referred to as a second packet.

If a packet is received, the input line card 110-1 may determine an output port to which the packet is transferred through an Internet protocol (IP) multicast address or a multicast medium access control (MAC) address. In further detail, the input line card 110-1 determines the SMID to be used to determine a partition ID (or partition identification information) of a partition to which at least one output port of the received first packet belongs and a position of an output port determined in the partition. The partition may be identified by the partition ID. The input line card 110-1 may determine the partition ID to which at least one output port of the first packet belongs and the SMID. The partition ID and the SMID determined in the input line card 110-1 may be referred to as multicast information of the first packet. Because the received first packet may be output to at least one output port, the input line card 110-1 may determine a plurality of pieces of multicast information for the first packet, and the number of pieces of generated multicast information may be the same as the number of partitions to which at least one output port of the first packet belongs.

If the first packet is received, the input line card 110-1 may generate replicas of the first packet in the same number as the number of identified partitions and generate a plurality of second packets by adding multicast information to the replicas of the first packet. That is, the second packet may include data of the first packet and multicast information of the first packet.

The switch fabric 120 may be configured to include at least one switch module. In further detail, the switch fabric 120 may be configured as one switch module or a multistage switch module. The switch fabric 120 may determine at least one output port to which the first packet is output on the basis of the multicast information included in the second packet, and output the first packet to the determined output port.

When the first packet is multicast using the multicast information included in the first packet, the switch fabric 120 may minimize the multicast information added to the first packet for multicasting the first packet, and minimize a size of the MFLT storing the output port information to be used to determine the output port corresponding to the multicast information. The output port information may be expressed by an output port bitmap indicating a position of an output port in a corresponding partition.

For example, when the switch has 1296 output ports, 1296 bits (162 bytes) are necessary in the existing method so as to express output port information indicating an output port position to which the first packet is output. However, when the output ports are grouped into 8 partitions, all pieces of the output port information may be expressed by 3+1296/8=165 bits, so that multicast patterns may be expressed by a small number of bits. According to the above-described example, a maximum of 2̂1296 values should be stored in the MFLT, but only 2̂165 entries may be stored and used according to an embodiment.

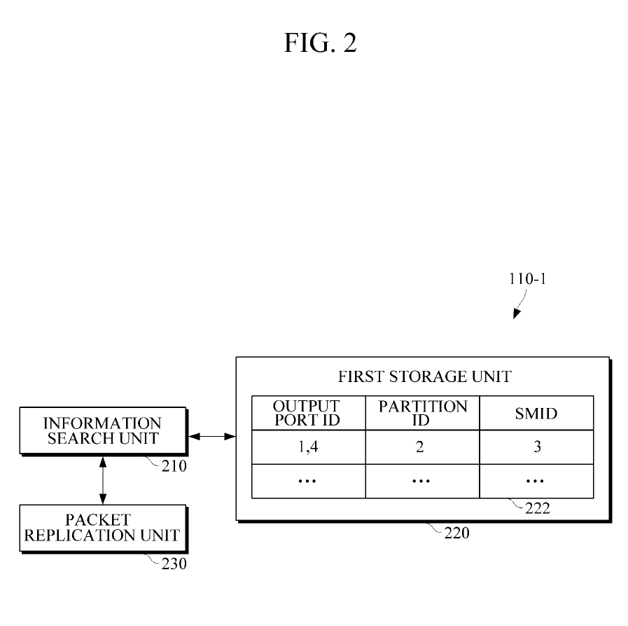

FIG. 2 is a diagram illustrating an example of a configuration of the input line card of FIG. 1.

The input line card #1 (110-1) may include an information search unit 210, a first storage unit 220, and a packet replication unit 230.

The information search unit 210 receives a first packet input from an outside. When the first packet, which is a multicast packet, is received, the information search unit 210 determines an external output port on the basis of a multicast IP address or a multicast MAC address included in the first packet. The information search unit 210 may determine at least one output port to which the received packet is output among a plurality of output ports of the switch fabric 120 through a protocol such as an Internet group management protocol (IGMP) or a protocol independent multicast (PIM) protocol.

The first storage unit 220 stores an MFLT 222 including an SMID and a partition ID of a partition configured according to at least one output port to which the first packet is output according to a multicast pattern of the first packet.

If at least one output port to which the received first packet is output is determined among a plurality of output ports of the switch fabric 120, the information search unit 210 may determine the partition ID and the SMID using the MFLT 222 stored in the first storage unit 220. The information search unit 210 may determine a switch port included in the switch fabric 120 connected to at least one output port.

The packet replication unit 230 generates replicas of an input packet in the same number is as the determined number of partitions, and adds an MRH including multicast information to each packet replica. At this time, the second packet may have a variable size. Alternatively, the first packet may be converted into a second packet in the form of a fixed-size cell.

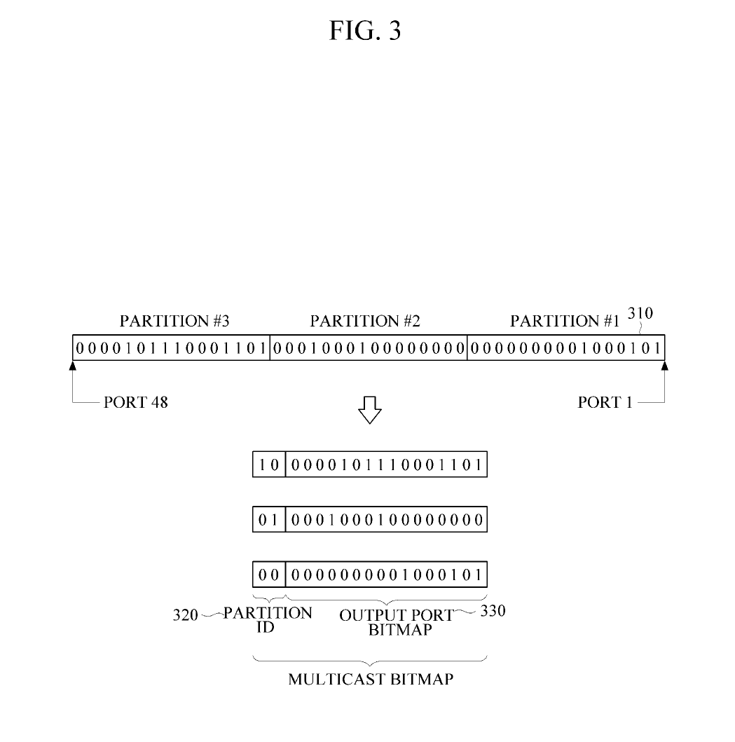

FIG. 3 is a diagram illustrating configurations of a partition ID and an SMID according to an embodiment.

Serial numbers, which are incremented by 1, are assigned to the output port ID and the partition ID. When the number of output ports is N and the number of partitions is P, a position of an output port to which a multicast packet is transferred in a k-th partition (partition #k) may be determined by a value of k×(N/P) and an output port ID.

In addition, when the output port information is expressed as output port bitmap information indicating an output port in a corresponding partition, a total N-bit bitmap is required to indicate an output port position to which the first packet is output in the method of the related art. However, according to the above-described embodiment, N output ports are grouped into P partitions, and only N/P bits are required to express partition-specific output port information.

Additionally, log₂P bits are required to identify the P partitions. Accordingly, a size of the multicast bitmap indicating a position of an output port to which the first packet is output may be reduced from N bits to (log₂P+(N/P)) bits. When the SMID is a bitmap indicating a position of an output port to which the first packet is output, the SMID may be expressed by N/P bits.

Reference numeral 310 of FIG. 3 denotes an example of a 48-bit bitmap.

According to an embodiment, a plurality of output ports are grouped into a plurality of partitions and a multicast bitmap may include a partition ID 320 and an output port bitmap 330 indicating an output port position in a corresponding partition. According to the configuration as described above, the multicast bitmap may be reduced to 18 bits. Among the 18 bits, 2 bits indicate the partition ID 320 and the remaining 16 bits indicate the output port bitmap 330 to which the partition belongs. As described above, when the partition ID 320 and the output port bitmap 330 of a corresponding partition are used, a size of the MFLT may be significantly reduced.

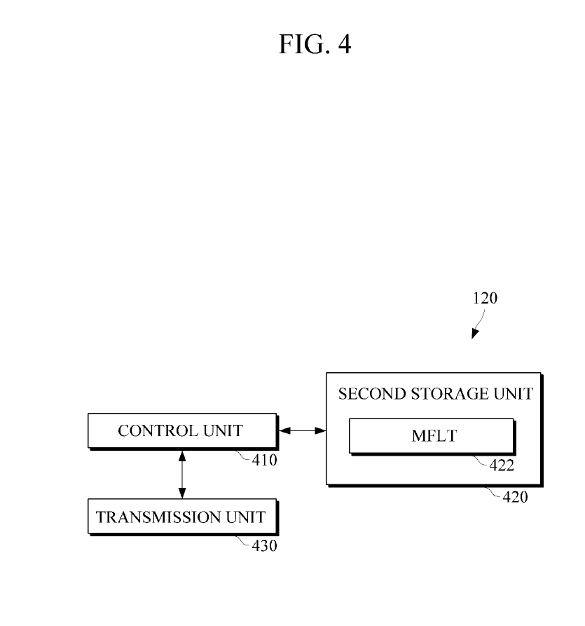

FIG. 4 is a diagram illustrating an example of a configuration of the switch fabric 120 of FIG. 1.

The number of replicas of a first packet to be multicast is the same as the number of partitions to be multicast in the input line card 110-1, and the replicas are input to the switch fabric 120. The switch fabric 120 may include a control unit 410, a second storage unit 420, and a transmission unit 430. When the switch fabric 120 includes a plurality of switch modules, the control unit 410, the second storage unit 420, and the transmission unit 430 may be configured separately for each switch included in the switch fabric 120. In addition, the second storage unit 420 is integrated into a configuration of the control unit 410 or the transmission unit 430.

The control unit 410 extracts a partition ID and an SMID from multicast information included in the input second packet, and determines output port information corresponding to the extracted partition ID and SMID.

The SMID may be an output port bitmap indicating a position of a partition-specific output port. Alternatively, the SMID may be a separate identification number or serial number indicating a position of a partition-specific output stage.

When the SMID included in the second packet has the form of the output port bitmap indicating a position of an output port of a partition corresponding to a partition ID, the control unit 410 may determine an output port to which the second packet is output only using the partition ID and output port bitmap information. However, when the SMID is a separate identification number or serial number indicating a position of a partition-specific output stage, the control unit 410 may determine an output port to which the second packet is output by referring to the MFLT indicating an output port position in a partition corresponding to the partition ID and the SMID.

The second storage unit 420 stores the MFLT including the partition ID and SMID-specific output port information. The output port information may be an output port bitmap indicating a position of an output port in a partition corresponding to the partition ID extracted from the second packet.

When the switch fabric 120 includes a multistage switch including a plurality of switch modules, the MFLT may have a local MFLT including a partition ID and output port information in each SMID-specific switch module as information for a plurality of switch modules to support multicast routing of the first packet.

The transmission unit 430 may transmit the second packet input according to control of the control unit 410 to at least one output port corresponding to searched output port information. The transmission unit 430 may remove multicast information added by the input line card 110-1 from the second packet, and output the second packet from which the multicast information has been removed, that is, the first packet.

In addition, when the SMID is a serial number indicating a position of an output port to which a packet is output according to each partition and the switch fabric 120 includes a single-stage switch, the packet may be transferred to an output port having an output port number determined by adding offset information indicating a first output port position included in a partition to which at least one output port of the received first packet belongs to the serial number.

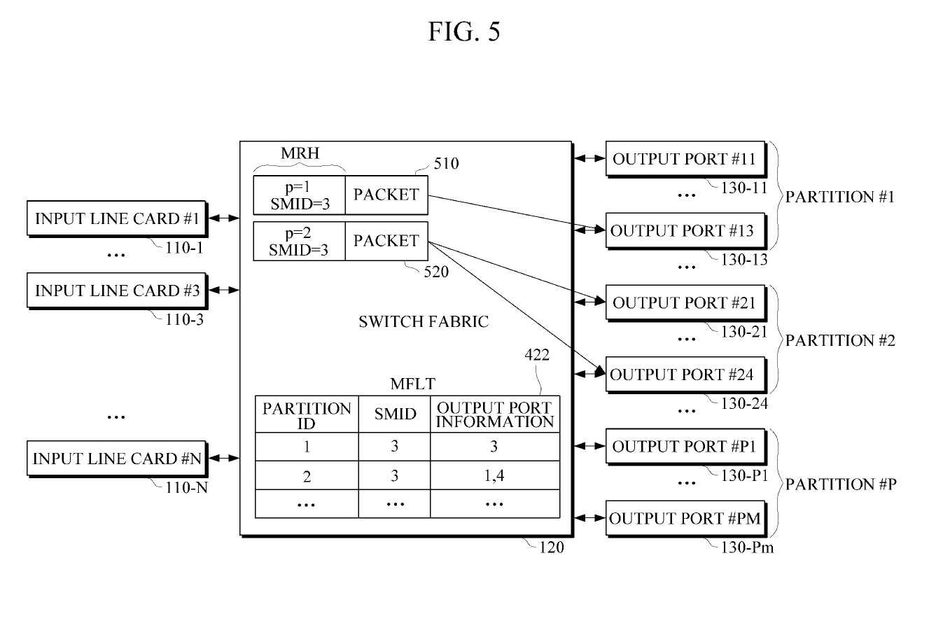

FIG. 5 is a diagram illustrating an example of an operation of the multicast packet forwarding apparatus according to an embodiment.

In FIG. 5, it is assumed that a packet input to the input line card #1 (110-1) is output to output ports included in partitions #1 and #2. In this case, the number of replicas of the packet input to the input line card #1 (110-1) is the same as the number of partitions of output ports to which the packet is output, 2, and a partition ID and an SMID may be added to an MRH of each of the packet replicas and input to the switch fabric 120.

It is assumed that multicast information in which a partition ID(p) is 1 and the SMID is 3 is included in an MRH of a packet 510 input to the switch fabric 120 and multicast information in which a partition ID(p) is 2 and the SMID is 3 is included in an MRH of a packet 520.

By referring to the MFLT 422, the switch fabric 120 may determine an output port of the input packet 510 as an output port of which output port information is 3. Accordingly, the packet 510 may be output to an output port 130-13 of which output port information of the partition #1 is 3. In addition, by referring to the MFLT 422, the switch fabric 120 may determine output ports of the input packet 520 as output ports 130-21 and 130-24 of which output port information is 1 and 4, and output the packet 520 to the output ports 130-21 and 130-24.

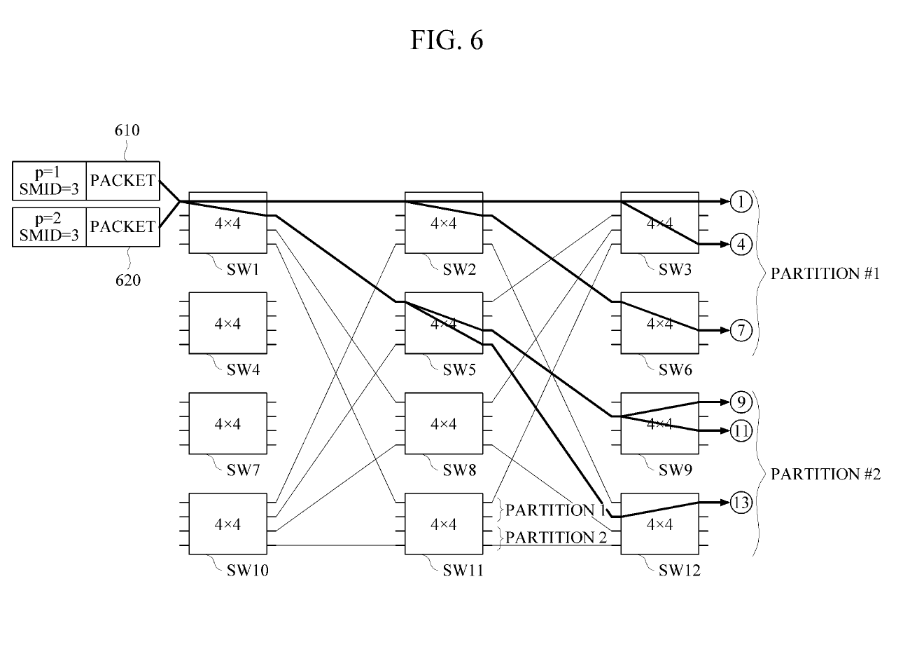

FIG. 6 is a diagram illustrating a configuration in which the switch fabric of the multicast packet forwarding apparatus is constituted by a multistage switch according to an embodiment.

To have scalability in a large-capacity switching system, the capacity of the system is increased using a 3-stage Clos switch or a multistage switching structure such as the Benes structure.

FIG. 6 illustrates a structure of the 3-stage Clos switch. When the switch structure of the 3-stage Clos scheme as described above is used, a (16×16) large-capacity switch may be configured by forming (4×4) switches in three stages. When a three- or five-stage (multistage) switch is configured using an N-input/output switch module in the existing technology, a scale may be extended to N̂2 or N̂3. Because multistage switch modules should be switched step by step in a large-capacity switch, a variable-size packet of an input stage is converted into a fixed-size cell and switched.

In this case, output ports 1 to 8 are grouped into a partition #1 and output ports 9 to 16 are grouped into a partition #2. Switch modules SW1 to SW2 may manage routing information for local multicast considering a multicast ID and a partition ID as an MFLT. That is, when a plurality of switch modules are included in the switch fabric 120, each switch module may manage its own MFLT as a local MFLT.

FIG. 6 illustrates the case in which input second packets 610 and 620 are multicast to output ports of which output port information is 1, 4, 7, 9, 11, and 13. The second packets 610 and 620 may be transferred to output ports according to a plurality of partition-specific multicast patterns in a process of making a change to a fixed-size cell for switching.

As illustrated in a second-stage switch module SW11 of FIG. 6, two higher ports among output ports of the switch module SW11 are used to transmit packets to output ports belonging to a third-stage partition 1, and two lower ports among the output ports of the switch module SW11 are used to transmit packets to output ports belonging to a third-stage partition 2. Accordingly, a size of a two-step output port bitmap may be reduced to the number of bits that is half the number of output ports provided in each switch module.

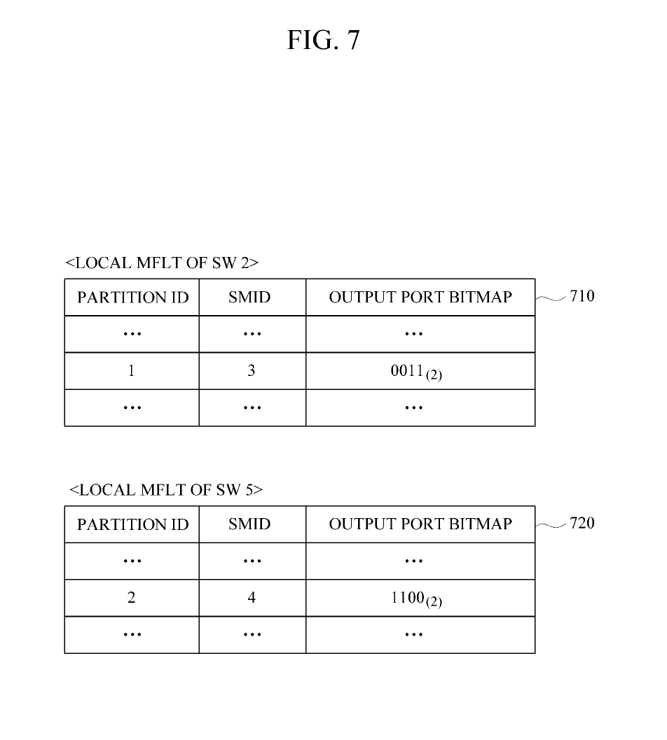

FIG. 7 is a diagram illustrating an example of an MFLT when the switch fabric of FIG. 6 is constituted by the multistage switch.

Among second-stage switch modules, a switch module SW2 and a switch module SW5 have local MFLTs 710 and 720, respectively. As illustrated in FIG. 7, the local MFLTs 710 and 720 may include output port bitmap information for a partition ID and an SMID. Here, the output port bitmap information indicates output ports to which packets are output among a plurality of output ports included in a switch module. For example, an output port bitmap of the local MFLT 710 of the switch module SW2 indicates a position of an output port to which a packet is output.

Referring to the local MFLT 710, because a value of an output port bitmap is 0011 when the partition ID is 1 and the SMID is 3, the packet 610 is output from third and fourth ports of the switch module SW2 (two higher output ports of the switch module SW2 in FIG. 6). Referring to the local MFLT 720, because a value of an output port bitmap is 1100 when the partition ID is 2 and the SMID is 4, the packet 620 is output from first and second ports of the switch module SW5 (two lower output ports of the switch module SW5 in FIG. 6).

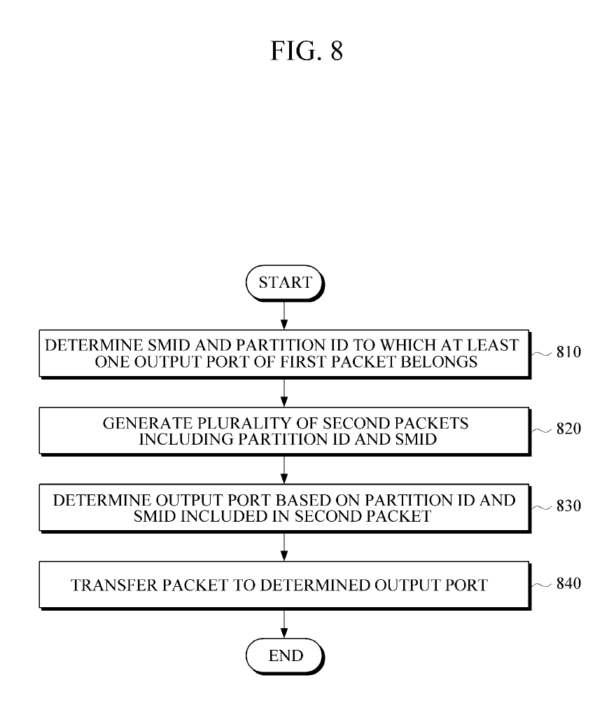

FIG. 8 is a flowchart illustrating a method of forwarding a multicast packet according to an embodiment.

In the multicast packet forwarding apparatus 100 in which a plurality of output ports are grouped into a plurality of partitions, an input line card determines a partition ID of a partition to which at least one output port of an input first packet belongs and an SMID to be used to determine a position of an output port in the partition (810).

The input line card generates a plurality of second packets having multicast information including the partition ID and the SMID (820).

The switch fabric receives the plurality of second packets, and determines at least one output port to which each second packet is transferred on the basis of multicast information of the received second packets, that is, partition IDs and SMIDs (830).

The switch fabric transfers the second packet to at least one determined output port (840). When the switch fabric transfers the second packet, the second packet from which the multicast information has been excluded is transmitted. Because the second packet is a replica packet for multicasting the first packet, the first packet may be consequently output from the switch fabric through an output port in a multicast mode.

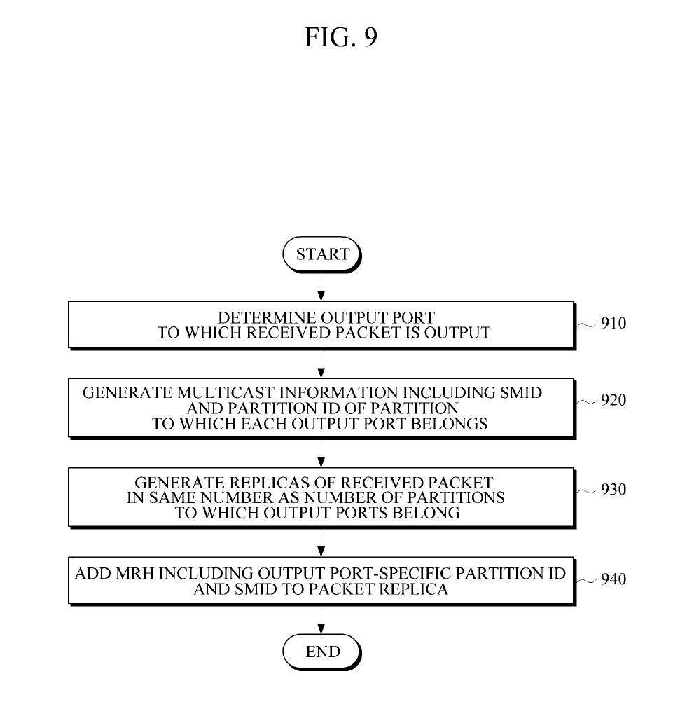

FIG. 9 is a flowchart illustrating an operation of the input line card according to an embodiment.

The input line card of the multicast packet forwarding apparatus 100 determines at least one output port to which a received packet is output (910).

The input line card generates multicast information including a partition ID of a partition to which at least one output port of an input first packet belongs and an SMID to be used to determine a position of an output port in the partition (920).

The input line card generates replicas of the received packet in the same number as the number of partitions to which output ports belong (930).

The input line card adds multicast information including an SMID and at least one output port-specific partition ID determined in the operation 910 as an MRH to the packet replica (940).

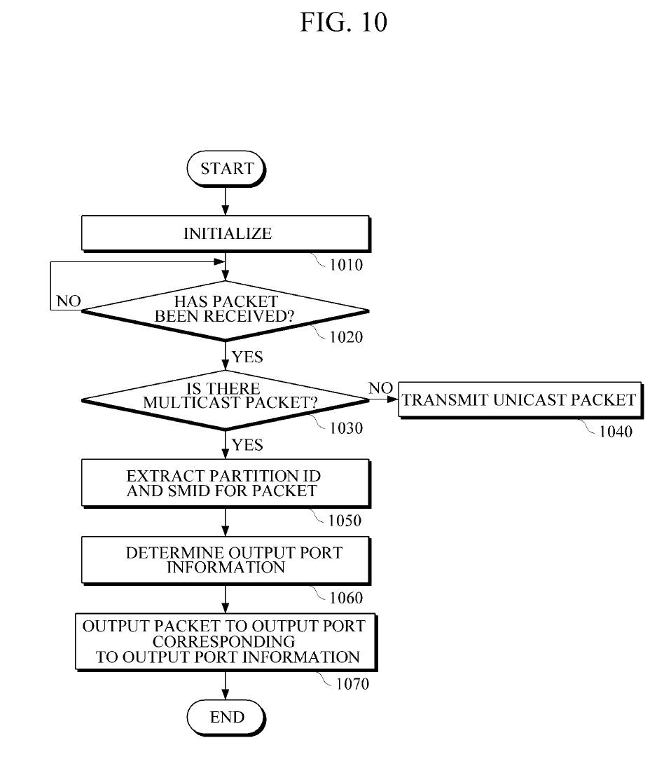

FIG. 10 is a flowchart illustrating an operation of the switch fabric according to an embodiment.

The switch fabric initializes parameter values for multicast (1010). In this step, information such as an MFLT, the total number of partitions, P, and the total number of output ports, N, connected to the switch fabric, may be initialized and set in the switch fabric.

When a packet (a second packet described above) is received (1020) and the received packet is a multicast packet (1030), the switch fabric extracts an SMID and a partition ID(p) is from a header of the packet (1050). The switch fabric determines output port information using the SMID and the partition ID(p) (1060).

The switch fabric outputs a packet to at least one output port corresponding to the determined output port information (1070). When a multistage switch is configured, the switch fabric may transfer a replicated packet to an output port corresponding to output port information retrieved from the MFLT. The SMID is a serial number indicating a position of an output port to which a partition-specific packet is output. When a single-stage switch is configured, the switch fabric may transfer a packet to an output port having an output port number determined by adding offset information indicating a first output port position included in a partition to which at least one output port of a received first packet is output to the serial number.

When the received packet is not the multicast packet (1030), the received packet may be transmitted as a unicast packet (1040).

The present invention may be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

According to the embodiments, the scalability of multicast is improved in a large-capacity switch. For example, it is possible to reduce the number of bits of an SMID from N bits to (N/P)+log₂P bits so as to indicate all multicast cases when N output ports are grouped into P partitions and multicast information is managed. Accordingly, it is possible to reduce a size of the MFLT to be stored for each switch module.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for forwarding a multicast packet, comprising:
an input line card configured to generate multicast information including a partition identifier (ID) to which at least one output port of a received first packet belongs and a switch multicast ID (SMID) to be used to determine a position of the output port in the partition, and generate second packets including the multicast information in the same number as the number of partitions;
a switch fabric configured to transfer the second packet to at least one output port to which the first packet is output on the basis of the multicast information included in the second packet; and
a plurality of output ports grouped into a plurality of partitions.

2. The apparatus according to claim 1, wherein the input line card generates replicas of the first packet in the same number as the number of partitions to which at least one output port of the first packet belongs, and generates the plurality of second packets by adding the multicast information to the replicas of the first packet.

3. The apparatus according to claim 1, wherein the multicast information is generated in the same number as the number of partitions to which at least one output port of the first packet belongs.

4. The apparatus according to claim 1, wherein the input line card includes:
a first storage unit configured to store a multicast information lookup table including the partition ID configured according to at least one output port to which the first packet is transferred and the SMID;
an information search unit configured to search for the partition ID for the at least one output port to which the first packet is output and the SMID from the multicast information lookup table; and
a packet replication unit configured to generate replicas of the first packet in the same number as the number of partitions to which the at least one output port belongs, and add a multicast routing header (MRH) including the multicast information to each packet replica.

5. The apparatus according to claim 1, wherein the switch fabric includes:
a second storage unit configured to store a multicast forwarding lookup table (MFLT) including a partition and SMID-specific output port information;
a control unit configured to extract multicast information included in the second packet and search for output port information corresponding to the extracted multicast information from the MFLT; and
a transmission unit configured to output the second packet to an output port corresponding to the output port information.

6. The apparatus according to claim 5, wherein the output port information is an output port bitmap indicating a position of an output port in a partition corresponding to the partition ID.

7. The apparatus according to claim 5, wherein, when the switch fabric is a multistage switch including a plurality of switch modules, the MFLT is configured to comprise a partition ID and output port information in each SMID-specific switch module as information for each of the plurality of switch modules to support multicast routing of the first packet.

8. The apparatus according to claim 1, wherein the SMID is a bitmap indicating the determined position of the output port.

9. The apparatus according to claim 1, wherein the SMID is a serial number indicating a position of an output port to which a packet is output according to each partition, and the switch fabric transfers the second packet to an output port having a determined output port number by adding offset information indicating a first output port position included in the partition to which at least one output port of the received first packet belongs to the serial number when a single-stage switch is configured.

10. The apparatus according to claim 1, wherein, when the number of output ports is N, the number of partitions is P, and the SMID is a bitmap indicating the determined position of the output port, the partition ID is expressed by log₂P bits and the SMID is expressed by N/P bits.

11. A method of forwarding a multicast packet in a multicast packet forwarding apparatus including an input line card, a switch fabric connected to the input line card, and a plurality of output ports connected to the switch fabric, the method comprising:
generating, by an input line card, multicast information including a partition ID to which at least one output port of an input first packet belongs and an SMID to be used to determine a position of the output port in the partition when the plurality of output ports are grouped into a plurality of partitions;
generating, by the input line card, second packets including the multicast information in the same number as the number of partitions; and
transferring, by a switch fabric, the second packet to at least one output port to which the first packet is output on the basis of the multicast information included in the second packet.

12. The method according to claim 11, wherein the generating of the second packets further comprises
generating, by the input line card, replicas of the first packet in the same number as the number of partitions to which at least one output port of the first packet belongs; and
generating the second packets by adding the multicast information to the replicas of the first packet.

13. The method according to claim 11, wherein the multicast information is generated in the same number as the number of partitions to which at least one output port of the first packet belongs.

14. The method according to claim 11, wherein the generating of the multicast information further comprises searching, by the input line card, for the multicast information from an MFLT including a partition ID configured for each of at least one output port to which the first packet is transferred and the SMID.

15. The method according to claim 11, wherein the transferring of the second packet further comprises:
transferring, by the switch fabric, the second packet to at least one output port to which the first packet is output on the basis of multicast information included in the second packet;
extracting the multicast information from an MRH included in the second packet;
searching for output port information corresponding to the extracted multicast information from an MFLT including a partition ID and SMID-specific output port information; and
outputting the second packet to an output port corresponding to the output port information.

16. The method according to claim 15, wherein the output port information is an output port bitmap indicating a position of an output port in a partition corresponding to the partition ID.

17. The method according to claim 15, wherein, when the switch fabric is a multistage switch including a plurality of switch modules, the MFLT is configured to comprise a partition ID and output port information in each SMID-specific switch module as information for each of the plurality of switch modules to support multicast routing of the first packet.

18. The method according to claim 11, wherein the SMID is a bitmap indicating the determined position of the output port.

19. The method according to claim 11, wherein, in transferring, by the switch fabric, the second packet, when the SMID is an identification number indicating a position of an output port to which a packet is output according to each partition and the switch fabric is a single-stage switch, the switch fabric transfers the second packet to an output port having a determined output port number by adding offset information indicating a first output port position included in the partition to which the at least one output port of the received first packet belongs to the identification number.

20. The method according to claim 11, wherein, when the number of output ports is N, the number of partitions is P, and the SMID is a bitmap indicating the determined position of the output port, the partition ID is expressed by log₂P bits and the SMID is expressed by N/P bits.
